(19) United States
(12) Patent Application Publication
(10) Pub. No.: US 2007/0121803 A1
(43) Pub. Date: May 31, 2007

(54) SYSTEM AND METHOD FOR DIRECT SUBSCRIBER POPULATION OF EMERGENCY SERVICES DATABASE RECORDS

(76) Inventors: Michael Arthur Koepke, Geneva, IL (US); Lawrence W. Ciesla, Yorkville, IL (US); Rahul Miglani, Arlington Heights, IL (US)

Correspondence Address: MICHELLE A. ZARINELLI;C/O WEST CORPORATION, 11808 MIRACLE HILLS DR., MAIL STOP: W11-LEGAL, OMAHA, NE, 68154, US

(21) Appl. No.: 11/554,975

(22) Filed: Oct. 31, 2006

Related U.S. Application Data
(60) Provisional application No. 60/732,466, filed on Nov. 1, 2005.

(51) Int. Cl. H04M 11/04

(52) U.S. Cl. 379/37

(57) ABSTRACT

A method to enable a subscriber to enter his or her address directly into a regional ALI database for use if and when the subscriber makes a 9-1-1 call. After a subscriber establishes telephony service in a new location, the subscriber connects to a processing system that can update a regional ALI that serves the subscriber's location. The subscriber is prompted to enter his or her telephone number and location information, optimally starting with the broadest location information (e.g., state) down to the narrowest (e.g., specific number street on a street). If the location information does not match a location recognized by MSAG, the subscriber is presented with one or more alternatives that are recognized by MSAG. When data entry is complete, the processing system stores the updated information and, advantageously, delivers the updated information to the ALI that serves the emergency service zone where the TN is now located.

### CROSS-REFERENCE TO RELATED APPLICATION

This Patent Application is related to and claims the benefit of U.S. Provisional Patent Application No. 60/732,466, entitled “System and Method for User Population of Emergency Services Database Records,” which was filed on Nov. 1, 2005, and is hereby incorporated by reference in its entirety.

### BACKGROUND OF THE INVENTION

The present invention is directed to providing accurate location information to public safety answering points, and, more specifically, to a system and method for direct subscriber population of emergency services database records that ensures that the format of the subscriber-entered data is usable by automatic location information databases and public safety answering points.

When abbreviated emergency services dialing (“9-1-1” in the U.S. and Canada) was first introduced, the emergency services operator had to ask the caller for, among other things, the location that the caller was calling from and a call-back telephone number. If the caller was unable to communicate this basic information to the operator, (because, for example, the caller was injured or does not speak the language), then help could not be dispatched.

To alleviate this problem, enhanced 9-1-1 (E9-1-1) was developed. In E9-1-1, the telephone number of the calling telephone is delivered with the call to the local public safety answering point (PSAP). The PSAP queries a regional Automatic Location Information (ALI) database using the calling telephone number as a key. The ALI database returns a record containing the street address and, in some cases, other information associated with the calling telephone number. The operator at the PSAP that takes the call is then presented with the calling telephone number and the street address associated with the calling telephone number. Such information aids the operator to call the telephone back in case the call is cut off for any reason and aids the operator in guiding help to the address of the caller.

To provide E9-1-1 capabilities for landline telephone subscriber in the current art, the physical address of the subscriber and the call-back number of the telephone must be provisioned in the appropriate ALI database in order to deliver that address to the PSAP. From the PSAP perspective, the address delivered must be in Master Street Address Guide (MSAG) format. For landline telephony, management and reconciliation of a subscriber's address so that the address is MSAG valid has been performed by the incumbent local exchange carriers (ILEC's), competitive local exchange carriers (CLEC's) or a contractor, such as Intrado (the assignee of the present invention).

The above-described system works very well in landline-based telephony, because telephone number and address changes occur slowly over time and in a manner easily tracked by the ILEC's or CLEC's. Today, however, there is a new line-based telecommunications system that is not based on landline telephony. Specifically, Voice over Internet Protocol (VoIP) telephony provides voice and data telecommunications without using the landline telephony infrastructure. Each VoIP telephone, however, has a 10-digit telephone number (TN) that is dialable from virtually any other VoIP, wireless or landline telephone.

In VoIP telephony, a subscriber can simply plug a VoIP telephone into a data network, such as the Internet and register the VoIP telephone with a VoIP service provider (VSP). The subscriber can then make and receive telephone calls with the full feature set subscribers expect. Further, a VoIP telephone can be unplugged and moved to any location that has an Internet connection. Additionally, wireless VoIP telephones are currently being developed and deployed. Wireless VoIP telephones can be used anywhere there is a wireless data access point (e.g., hotels, office buildings, coffee shops, etc.) As a result, many people are switching to VoIP telephony for convenience, technology or cost reasons.

With the movement of consumers to VoIP technology, VSP's and Wireless carriers that provide fixed or wireless VoIP 9-1-1 service (respectively) must provide each subscribers' civic address in order to maintain regional ALI databases in a manner consistent with E9-1-1 practice. Currently, the VSP obtains the subscriber's civic address and then send it to Intrado over a machine-machine interface. Intrado then converts this address to a MSAG-valid format and provides updates to the regional ALI databases.

The problem with this approach is that the subscriber-provided civic address and the PSAP-ready address in MSAG format may not easily translate and there is a high error rate when performing the translation, which results in an error record. A human is then required to manually resolve the subscriber's civic address to its correct MSAG-valid address. Until this manual reconciliation occurs, the PSAP will not receive the VoIP subscriber's address during an emergency call. Effectively, the subscriber only has Basic 9-1-1 service, not Enhanced.

Therefore, a problem in the art is that there is no simple, efficient system for maintaining an emergency services database for movable telephones.

### SUMMARY OF THE INVENTION

This problem is solved and a technical advance is achieved in the art by a system and method that enables a subscriber to enter his or her address electronically, which is then validated against the official Master Street Address Guide (MSAG) and then delivered to the regional ALI system that serves the location of the subscriber. As a result, there is a high probability of the subscriber's address being available to the PSAP upon a 9-1-1 call, which effects nearly universal E9-1-1 service. To allow the greatest opportunity for direct subscriber 9-1-1 address entry, a Web-based application is provided by this invention that walks the subscriber through the process of entering their 9-1-1 address.

In accordance with one aspect of this invention, when a subscriber establishes telephony service in a new location, the subscriber connects to a processing system that can update a regional ALI that serves the subscriber's location. The subscriber is prompted to enter his or her telephone number (TN) or other unique identifier appropriate for the subscriber's network (e.g., MAC address, URI, etc.). Alternatively, the subscriber's TN or other identifier is captured or passed to the processing system. The subscriber is then prompted for location information, optimally starting with the broadest location information (e.g., state) down to the narrowest (e.g., specific number street on a street). If the location information does not match a location recognized by MSAG, the subscriber is presented with one or more alternatives that are recognized by MSAG. When data entry is complete, the processing system stores the updated information and, advantageously, geo-codes the location just entered. The emergency services number for the location is then determined and is delivered to the ALI that serves the emergency service number where the TN is now located. Further advantageously, the geo-coded location is presented to the subscriber on a map so that the subscriber may verify his or her location.

Additionally, this invention provides for a plurality of “alias” names for communities, streets and street numbers. For example, a street may be known by a route name a street name, or both (e.g., Route 38 and Roosevelt Road) but may be designated differently by the MSAG (e.g., Main Street). All known aliases of a name are selectable in accordance with this aspect of this invention, and are then changed into the MSAG-valid name.

### BRIEF DESCRIPTION OF THE DRAWINGS

A more complete understanding of this invention may be obtained from a consideration of this specification taken in conjunction with the drawings, in which:

FIG. 1 illustrates a block diagram of a communications network in which an exemplary embodiment of this invention operates;

FIG. 2 is a first screen shot of a data entry screen in accordance with one aspect of this invention;

FIG. 3 is a second screen shot of another data entry screen in accordance with another aspect of this invention; and

FIGS. 4A-C comprise a flowchart of operations of an exemplary embodiment of this invention in the context of the communications network of FIG. 1.

### DETAILED DESCRIPTION

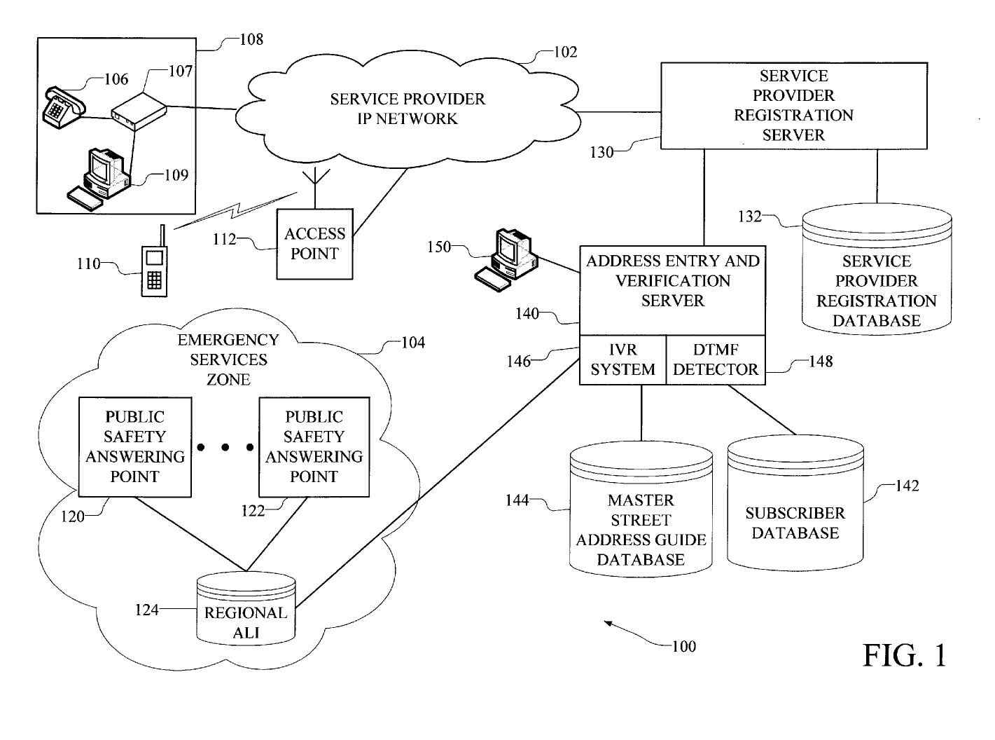

FIG. 1 is a block diagram of a communications network 100 in which an exemplary embodiment of this invention operates. Certain aspects that are typical of a communications network but not essential to the description of this invention are not illustrated for the sake of clarity. This invention is described in the context of a registering the address of a VoIP telephony device. One skilled in the art will realize that this invention may be used in the area of landline telecommunications and even wireless telecommunications after studying this specification.

Communications network 100 generally includes a service provider IP network 102 and an emergency services zone (ESZ) 104. Service provider IP network 102 provides VoIP telephony services to telephone 106 via modem 107 at subscriber premises 108. Subscriber premises also includes a means to access a data network, represented here by personal computer (PC) 109. Telephone 106, modem 107 and PC 109 are exemplary. One skilled in the art will realize that all of these items may be one unit, two units or more. Additionally, telephone 106 may be a POTS telephone plugged into modem 107, as is known in the art. VoIP telephone 106 as used herein means any device that can communicate on service provider IP network via voice, data or, preferably both.

Alternatively, a VoIP wireless device 110 may be connected to service provider IP network 102 via access point 112. VoIP wireless device 110 may be a wireless telephone, a personal digital assistant (PDA), a laptop, or any other wireless device that can send and receive voice, data or preferably both. VoIP wireless device 110 and access point 112 are known in the art and are therefore not further described. For purposes of brevity, “VoIP telecommunications device” is used to mean VoIP telephone 106, VoIP wireless device 110 or both.

ESZ 104 comprises a plurality of public safety answering points, represented by public safety answering point (PSAP) 120 and PSAP 122. PSAP's 120 and 122 each serve a geographical region within an ESZ, as is known in the art. Each PSAP 120, 122 within the ESZ 104 is also connected to regional ALI 124. Regional ALI 124 comprises a database that stores every TN (or other unique identifier) within the region and an address or location associated with every TN. ESZ 104 is well known in the art and therefore not described further.

In order to operate in service provider IP network 102, VoIP communications devices must be registered with service provider IP network 102. To this end, whenever the subscriber of a VoIP communications device first initiate contact with service provider IP network 102, the VoIP communications device contacts service provider registration server 130. Service provider registration server 130 receives information from VoIP telephone 102 or VoIP wireless device 110. Such information includes the device's TN, MAC address, URI or any unique identification that globally identifies the VoIP communications device. Service provider registration server 130 stores this information in service provider registration database 132 for use in service provider IP network 102. The information in service provider registration database 132 is used by routers, soft switches, etc., so that VoIP communications devices may communicate on service provider IP network 102, including placing and receiving telephone calls.

As part of registration, and in contradiction to the prior art, service provider registration server 130 passes the call on to address entry and verification server 140, in accordance with an exemplary embodiment of this invention. Advantageously, service provider registration server 130 pass the TN, MAC address, or other unique identifier that the subscriber registered to address entry and verification server 140. Address entry and verification server 140, as will be described further, below, interacts with the subscriber registering the VoIP communications device to obtain the location of the VoIP communications device. Address entry and verification server 140 presents the subscriber with a series of menus from which the subscriber selects the location of the VoIP communications device. Advantageously, the menus start with the broadest areas (e.g., country or state) and works down to as precise a location as possible (e.g., street number, apartment number, hotel room number, etc.).

Alternatively, address entry and verification server 140 may include an interactive voice recognition (IVR) system 146, either as part of address entry and verification server 140 (as illustrated) or as a separate unit. IVR system 146 interacts with the subscriber and receives input verbally as is known in the art. Further alternatively, address entry and verification server 140 may include a dual-tone, multi-frequency (DTMF) detector 148. DTMF detector may be part of IVR system 146 or may be a separate unit. DTMF detector 148 accepts input from the subscriber as touch-tone signaling. In this manner, the subscriber does not necessarily have to have access to a computer or web-enabled device.

Once the address for the TN is obtained, in accordance with one aspect of this invention, the address is geo-coded and its ESN are determined. The TN (or other identifier), address, ESN and other data are stored in subscriber database 142 and delivered to the regional ALI database in the emergency services network that serves the location (address) of the VoIP communications device. In this exemplary embodiment, address entry and verification server 140 delivers the TN and address to regional ALI 124, which serves emergency services network 106.

For an address to be usable at PSAP's 120 and 122 in emergency services network 106, the address must be stored in a recognized format in regional ALI 124. In accordance with this embodiment of this invention, address entry and verification server 140 cooperates with Master Street Address Guide (MSAG) database 144 to produce an MSAG-valid address. An MSAG-valid address is one that includes the correct spellings of community and street names, valid streets in a community, valid street numbers on a particular street, etc. Such MSAG-valid addresses are currently the only addresses permitted by ILEC's, CLEC's or both to be stored in regional ALI 124. MSAG database 144, as is known in the art, contains all known, valid street addresses in the United States.

Therefore, in accordance with this invention, address entry and verification server 140 takes the subscriber's input for the broadest region and obtains data for further menus from MSAG database 144. If all or part of a subscriber's address is not located in MSAG database 144, then a list of potential valid entries is presented to the subscriber. If the subscriber still cannot find part of the address, then the interactive session is sent to an error handling system 150, which may include a live operator, to resolve the discrepancy. In this manner, new streets, subdivisions, etc. may be determined at an earlier stage than currently possible. Once the new location is verified, it can then be entered into MSAG database 144 for future use.

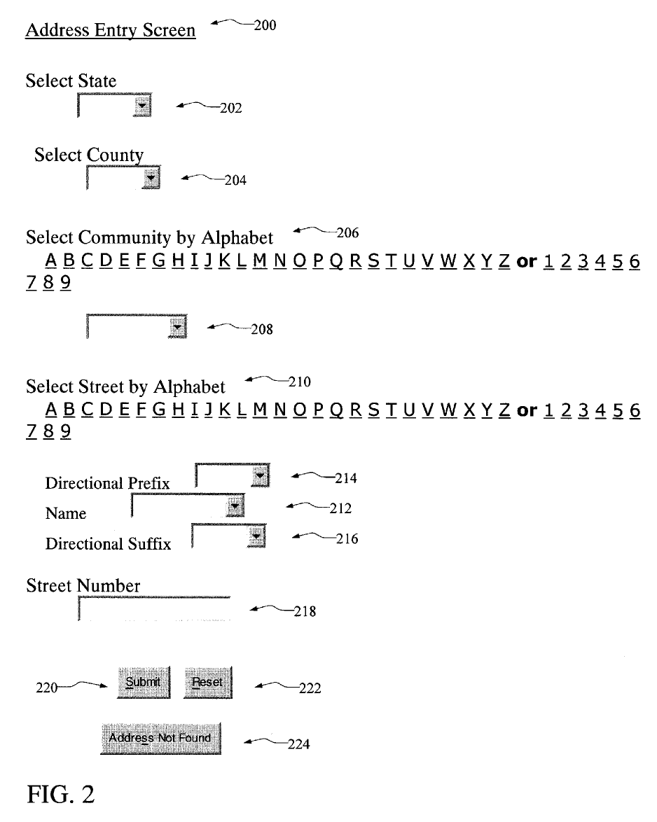

Turning now to FIG. 2, an entry screen in accordance with an aspect of this invention is illustrated generally at 200. In accordance with this invention, the address entry application is list driven. The application generates a record for the subscriber, which includes the TN or other identifier. If the TN or other identifier is not delivered when the application begins, the subscriber is prompted for the VoIP communications device's TN (not shown). Furthermore, address entry screen may display the TN or other identifier, request verification of the TN or other identifier, or, advantageously, both.

The application first prompts the subscriber for his or her State 202 (out of 51 possible, including the District of Columbia) in a drop down list. After the State selection is made, a list of counties 204 for that State (as determined from MSAG database 144) is presented. The subscriber selects his or her county form drop-down list 204.

Next, the application prompts the subscriber for his or her community 206, from a list of communities in the county. Advantageously, the subscriber selects the first letter or number of the community, which shortens the list presented at drop-down list 208. The subscriber selects his or her community in civic or postal format. If the civic or postal format is an alias of an MSAG-valid community, the application substitutes the MSAG-valid community name.

Once the community is selected, a list of MSAG-valid street names 210 that exist in the community is presented. Advantageously, the subscriber first selects the first letter or number of the street name to limit the drop-down selection presented in drop-down list 212. As with communities, the street names 212 are presented in their civic/postal format with the application mapping the correct MSAG street name via MSAG database 144. Any such mapping of civic/postal format to MSAG-valid format is perform transparently to the subscriber.

Additionally, any street directional prefix 214 and/or Suffix (i.e., N, S, E, W, NW, NE, SW, SE) 216 can be selected. Besides the valid MSAG street names, aliases for the streets are also presented as valid choices (Alias: Route 53 MSAG street name: Bryant Ave.). After completing street name selection, the subscriber then enters his or her street number 218 in free-form format and submits hs or her form by clicking on button 220. The subscriber may also elect to reset the form 222 and start over at any time. The street number is compared against MSAG-valid street number ranges. Upon successfully submitting the form, the subscriber is informed that he or she has successfully entered their 9-1-1 valid address. Advantageously, a map is displayed to the subscriber showing the entered location in the context of the community.

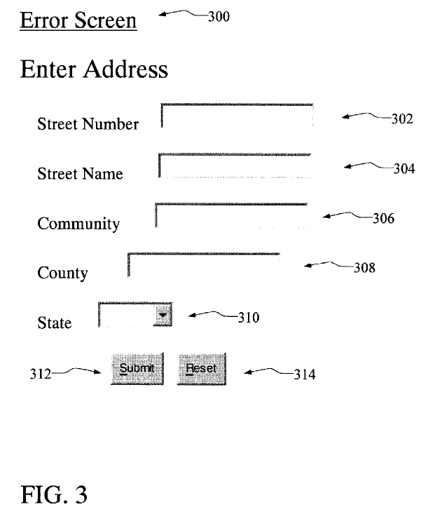

If at any time the subscriber cannot resolve his or her address, the subscriber may click on the “Address Not Found” button 224. Processing then moves to Error Screen 300 of FIG. 3. On error screen 300, the subscriber enters his or her street number 302, street name 204, community 306, county 208 and state 310. The subscriber then submits 312 the entered address or resets 314 the page and start over. This address is then sent to error handling 150 (FIG. 1) for reconciliation. Such reconciliation may be performed manually by a human performing a data lookup or by contacting the subscriber.

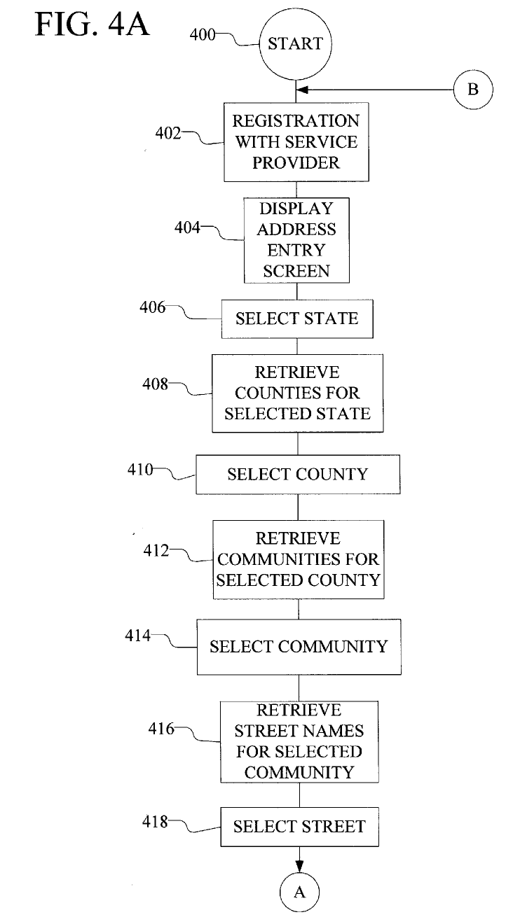

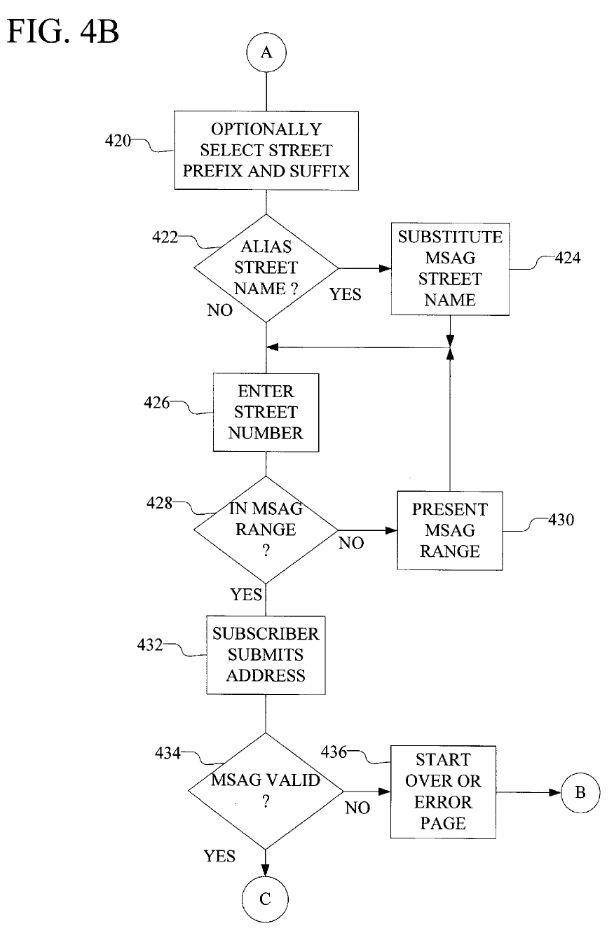

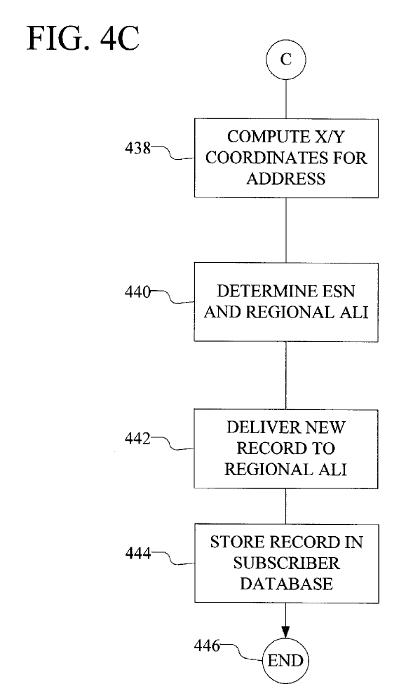

Turning now to FIGS. 4A-C, a flow chart of operations performed as address entry and verification server 140 is shown. Processing starts in FIG. 4A in circle 400 and moves to action box 402, where the subscriber registers his or her VoIP communications device with service provider registration server 130. Process then moves to address entry and verification server 140, where address entry screen 200 is presented to the subscriber in action box 404.

Processing next moves to action box 406, where the subscriber selects a state from drop-down menu 202. In action box 408, address entry and verification server 140 retrieves the MSAG-valid counties for the selected state. Next, the subscriber selects a county from drop-down menu 204 in action box 410. In action box 412, address entry and verification server 140 retrieves communities for the selected county from MSAG database 144. Next, in action box 414, the subscriber selects a community from drop-down menu 208.

Processing proceeds to action box 416, where address entry and verification server 140 retrieves street names for the selected community from MSAG database 144. In action box 418, the subscriber selects a street name from drop-down list 214. Processing continues through connector A to FIG. 4B.

Turning now to FIG. 4B, processing enters through connector A and moves to action box 420, where the subscriber optionally selects a street prefix, a street suffix or both. Processing continues to decision diamond 422, where address entry and verification server 140 determines whether the selected street name is an alias for an MSAG-valid street name. If it is, then processing moves to action box 424, where the MSAG-valid street name is substituted for the alias.

Processing proceeds to action box 426 from decision diamond 422, if the entered street name is not an alias and from action box 424, where the subscriber enters the street number in entry form 218. In decisional diamond 428, a determination is made whether the street number is within MSAG range. If it is not, then the subscriber may be presented with an MSAG-valid range in action box 430 and processing returns to action box 426.

When an MSAG-valid street number is selected, as determined in decision diamond 428, then processing moves to action box 432, where the subscriber submits the address by clicking on submit button 220. In decision diamond 434, a determination is made whether the entered address is an MSAG-valid address. If it is not, then processing moves to action box 436, where the subscriber is prompted to start over, or moves through connector B, where the subscriber starts again at action box 404. If the entered address is MSAG valid, as determined in decision diamond 434, then processing moves through connector C to FIG. 4C.

Turning now to FIG. 4C, processing enters through connector C and moves to action box 438, where the geo-coordinates (X/Y coordinates) are computed. Processing continues to action box 440, where the emergency services zone that serves the new address and the regional ALI are determined. In action box 442, the new record is delivered to the regional ALI as determined in action box 440. The record is also stored in subscriber database 142, in action box 444. Processing ends in circle 444.

Of course, at any time prior to clicking on submit button 220, the subscriber may click on reset button 222, which causes processing to move back to action box 404. Additionally, if the subscriber does not find an MSAG-valid entry in any of the fields, the subscriber may click on the address not found button 224, which moves the subscriber to error screen 300 (FIG. 3).

It is to be understood that the above-described embodiment is merely illustrative of the principles of the present invention and that many variations of the above-described embodiments can be devised by one skilled in the art without departing from the scope of the invention. For example, the data entry menus may be presented in a verbal manner, as is known in the art, and selections made using dual-tone, multi-frequency signaling. Further, data entry may be accomplished via interactive speech recognition. It is therefore intended that such variations be included within the scope of the following claims and their equivalents.

1. A method to effect subscriber entry of address information upon establishing a new service location for use by emergency service providers, said method comprising:
entering a plurality of data that describe the new service location;
validating said plurality of data against a master street address guide database;
determining a regional automatic location information database that serves the new service location if the plurality of data is valid; and
correcting non-valid data if the plurality of data is not valid.

2. A method in accordance with claim 1 wherein entering a plurality of data comprises entering each data item from the broadest location to the narrowest.

3. A method in accordance with claim 1 wherein validating said plurality of data against a master street address guide database occurs after all of said plurality of data is entered.

4. A method in accordance with claim 1 wherein validating said plurality of data against a master street address guide database occurs after entry of each data item.

5. A method in accordance with claim 1 wherein said entering a plurality of data comprises entering a plurality of data on a web-based data screen.

6. A method in accordance with claim 1 wherein said entering a plurality of data comprises entering a plurality of data verbally.

7. A method in accordance with claim 1 wherein said entering a plurality of data comprises entering a plurality of data using dual-tone, multi-frequency signaling.
